(19) United States
(12) Patent Application Publication
(10) Pub. No.: US 2022/0105630 A1
(43) Pub. Date: Apr. 7, 2022

(54) METHOD AND SYSTEM FOR AUGMENTING AND SHARING ROBOT INTELLIGENCE BASED ON CONTAINER

(71) Applicant: COMMON COMPUTER INC., Seoul (KR)

(72) Inventors: Minhyun KIM, Seoul (KR); Dongil SEO, Seoul (KR); Seonghwa YUN, Seongnam-si (KR); Hongmin YANG, Yongin-si (KR); Donghyeon CHOI, Uijeongbu-si (KR)

(21) Appl. No.: 17/405,856

(22) Filed: Aug. 18, 2021

(30) Foreign Application Priority Data
Oct. 7, 2020 (KR) 10-2020-0129712

(51) Int. Cl. B25J 9/16

(52) U.S. Cl. CPC B25J 9/1661; B25J 9/161; B25J 9/1628

(57) ABSTRACT

Provided is a method for augmenting and sharing a robot intelligence based on a container, in which the method is performed by at least one processor of an information processing system and includes transmitting at least one of information on one or more robots or information on intelligence registered in a registry to a user terminal, receiving a command for controlling the one or more robots based on the intelligence registered in the registry from the user terminal, and storing information associated with the received command in a database capable of communicating with the one or more robots.

### CROSS-REFERENCE TO RELATED APPLICATION

This application claims priority under 35 U.S.C. § 119 to Korean Patent Application No. 10-2020-0129712, filed in the Korean Intellectual Property Office on Oct. 7, 2020, the entire contents of which are hereby incorporated by reference.

### BACKGROUND OF THE INVENTION

### Technical Field

The present disclosure relates to a method and a system for augmenting and sharing a robot intelligence based on a container, and more specifically, to a method and a system for augmenting and sharing a robot intelligence based on a container, which augment the robot intelligence or share the intelligence between robots by using a container.

### Description of Related Art

In general, a robot may refer to a device that automatically processes a given task using a certain level of intelligence. Recently, robots that execute specific tasks in various fields are continuously being developed, and additional performance improvement of robots is being made according to the development of the 4th industrial revolution technology. However, adding new functions to the existing robot or improving existing functions is a difficult problem that requires replacement of hardware or change of software of the robot.

In particular, in order to improve the robot intelligence, it is necessary to develop software and hardware capable of implementing the intelligence optimized for the robot based on comprehensive consideration of the operating system, system structure, resource, and the like of the robot. In addition, in order to share the developed intelligence with other robots, there is a problem in that the task of modifying or supplementing the hardware or software related to intelligence need to be additionally performed according to the operating system, system structure, resource, and the like of the other robots.

### SUMMARY

In order to solve the above problems, there are provided a method for, a non-transitory computer-readable recording medium storing instructions for, and a device (system) for augmenting and sharing a robot intelligence based on a container, which are capable of effectively augmenting or sharing the intelligence without changing hardware or operating system and the like of the robot.

In addition, there are provided a method for, a non-transitory computer-readable recording medium storing instructions for, and a device (system) for operating a robot based on a container.

The present disclosure may be implemented in a variety of ways, including a method, a device (system), or a non-transitory computer-readable storage medium storing instructions.

According to an embodiment of the present disclosure, a method for augmenting and sharing a robot intelligence based on a container is provided, which may be performed by at least one processor of an information processing system and which may include transmitting at least one of information on one or more robots or information on intelligence registered in a registry to a user terminal, receiving a command for controlling the one or more robots based on the intelligence registered in the registry from the user terminal, and storing information associated with the received command in a database capable of communicating with the one or more robots.

According to an embodiment, the information on the one or more robots may include at least one of a list of robots including the one or more robots, types of intelligences running on the one or more robots, or a number of intelligences running on the one or more robots.

According to an embodiment, the command for controlling the one or more robots may include at least one of a command for executing a specific intelligence on the one or more robots, a command for stopping a specific intelligence running on the one or more robots, a command for stopping all intelligences running on the one or more robots, or a command for outputting a status of a software platform for the one or more robots.

According to an embodiment, the method may include receiving data generated by executing a task from the one or more robots that execute the task based on the information stored in the database, transmitting the received data to an intelligence augmentation system, receiving an intelligence augmented on the received data from the intelligence augmentation system, and registering the intelligence received from the intelligence augmentation system in the registry.

According to an embodiment, there is provided a non-transitory computer-readable recording medium storing instructions for executing on a computer the method for augmenting and sharing robot intelligence based on a container described above.

According to an embodiment, the information processing system may include a communication module, a memory, and at least one processor connected to the memory and configured to execute at least one computer-readable program included in the memory. The at least one program may include instructions for transmitting at least one of information on one or more robots or information on intelligence registered in a registry to a user terminal, receiving a command for controlling the one or more robots based on the intelligence registered in the registry from the user terminal that received the information, and storing information associated with the received command in a database capable of communicating with the one or more robots.

According to an embodiment, a method for operating a robot based on a container may be provided, in which the method may be executed by at least one processor of the robot and may include searching a database capable of communicating with an information processing system to determine whether or not a command associated with controlling of the robot is included, when the command associated with controlling of the robot is included, receiving a container-based intelligence corresponding to the command from the information processing system, and executing a task using the received container-based intelligence.

According to an embodiment, the robot may include a control unit capable of communicating with the information processing system, and a software platform capable of using intelligence.

According to an embodiment, the method may further include collecting data according to the executing of the task, transmitting the collected data to one or more other robots, and receiving task results generated based on the data from the one or more other robots.

According to an embodiment, the transmitting the collected data to one or more other robots may further include transmitting the collected data to the one or more other robots that are capable of communication using at least one of socket communication, ROS, or REST.

According to an embodiment, the method may further include determining whether or not the robot includes a computing resource to process the collected data. The transmitting the collected data to one or more other robots may include, in response to determining that the robot does not include computing resource to process the collected data, transmitting the collected data to the one or more other robots.

According to an embodiment, there is provided a non-transitory computer-readable recording medium storing instructions for executing on a computer the method for operating a robot based on a container described above.

According to various embodiments, user can efficiently process a task using the robot by utilizing the continuously-augmented intelligence, and by use of the software platform, the robot may utilize the augmented intelligence regardless of factors (e.g., system environment, computing resources, and the like) required to operate the intelligence.

According to various embodiments, the user can easily check the information on the currently available robots, and control various tasks of the robot through a simple touch input or the like through the user interface.

According to various embodiments, the user can utilize a container-based intelligence to efficiently execute tasks using various robots without modifying a system environment or the like of the robot.

According to various embodiments, even when the computing resource of the specific robot is insufficient, the user can process the collected data using another robot and the like, so that the user can command to execute tasks efficiently without being limited to the computing resource of the specific robot.

### BRIEF DESCRIPTION OF THE DRAWING

Embodiments of the present disclosure will be described with reference to the accompanying drawings described below, where similar reference numerals indicate similar elements, but embodiments are not limited thereto, in which:

FIG. 1 is a diagram illustrating an example of augmenting robot intelligence and sharing the augmented intelligence between a user, an information processing system, and a plurality of robots according to an embodiment;

FIG. 2 is a schematic diagram illustrating a configuration in which the information processing system is communicatively connected to a plurality of user terminals in order to control a robot and share augmented intelligence according to an embodiment;

FIG. 3 is a block diagram illustrating an internal configuration of the user terminal and the information processing system according to an embodiment;

FIG. 4 is a diagram illustrating an example of an initial user interface including information on robot, information on intelligence registered in a registry, and the like according to an embodiment;

FIG. 5 is a diagram illustrating an example of a user interface that includes detailed information on one robot according to an embodiment;

FIG. 6 is a functional block diagram illustrating an internal configuration of the information processing system according to an embodiment;

FIG. 7 is a functional block diagram illustrating an internal configuration of a control unit according to an embodiment;

FIG. 8 is a functional block diagram illustrating an internal configuration of a robot according to an embodiment;

FIG. 9 is a diagram illustrating an example in which communication is performed between a plurality of robots according to an embodiment;

FIG. 10 is a diagram illustrating an example of a method for augmenting and sharing a robot intelligence based on a container according to an embodiment; and

FIG. 11 is a diagram illustrating an example of a method for operating a robot based on a container according to an embodiment.

### DETAILED DESCRIPTION OF THE INVENTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the present embodiments are merely provided to make the present disclosure complete, and to fully disclose the scope of the invention to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. In addition, the “memory” should be interpreted broadly to encompass any electronic component capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with a processor is in electronic communication with the processor.

In the present disclosure, a “container” may refer to a virtualized runtime environment for a user to isolate a specific application program on a computing system such as a robot. In addition, a “container-based intelligence” may refer to a robot intelligence template (e.g., an artificial neural network model or source code trained to execute a specific task, or an image of the source code, and the like) generated using a virtualized system environment so as to be executed in the robot regardless of a system environment (e.g., computing resources, memory, and the like) of the robot. That is, the container-based intelligence these characteristics may be executed under the same conditions in several types of robots with different system environments. In this example, the robot may include a software platform to implement the container-based intelligence.

In the present disclosure, a “software platform” is a software virtualization platform installed, implemented, or included in a robot to execute the container-based intelligence, and may include a Docker platform, a Kubernetes platform, and the like, for example. According to an embodiment, the robot may execute the container-based intelligence using the software platform.

In the present disclosure, a “robot” may refer to a system that communicates with an information processing system and includes a software platform for executing container-based intelligence for executing a required action or task. According to an embodiment, the robot may be connected to, or include an edge cloud and a center cloud, and each robot may correspond to a robot having the same or different running intelligences, computing resources, system environments, and the like.

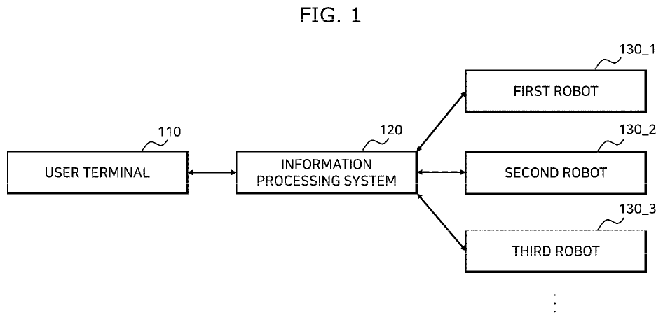

FIG. 1 is a diagram illustrating an example of augmenting robot intelligence and sharing the augmented intelligence between a user terminal 110, an information processing system 120, and a plurality of robots 130_1, 130_2, and 130_3 according to an embodiment of the present disclosure. The user terminal 110 may communicate with the information processing system 120 and control the plurality of robots 130_1, 130_2, and 130_3. Specifically, the user terminal 110 may receive information on a currently available robot, a currently available intelligence, and the like from the information processing system 120, and then transmit a command to the specific robot to execute a task using the specific intelligence using the received information.

According to an embodiment, the user terminal 110 may receive information on a robot 130, information on intelligence registered in the registry, and the like, from the information processing system 120. In this example, the information on the robot 130 may include a list of robots including robots that are currently capable of communication, the types of intelligences running on the robot, the number of intelligences running on the robot, and the like, but embodiments are not limited thereto, and it may further include any information associated with the robot. For example, the information on the robot 130 may further include a name of the robot, a current location of the robot, and the like. In this case, the registry is a storage space in which the intelligence executable by the robot 130 is registered, and may refer to any storage medium in which augmented intelligence is registered based on data collected by the robot.

The received information on the robot 130, information on intelligence, and the like may be displayed on a display of the user terminal 110. That is, a user interface including the received information may be displayed on the display of the user terminal 110. In this case, the user interface may further include information on an Application Programming Interface (API) that may be used to control the robot 130. The user may simply check currently available robots and intelligence based on the information on robot received by the user terminal 110 through the user interface, the information on intelligence registered in the registry, and the like.

According to an embodiment, the user terminal 110 may transmit a command for controlling the robot 130 to the information processing system 120. Specifically, the user may select the information on the robot 130, the information on intelligence, the information on API, and the like displayed on the user interface provided, through a touch input or the like, to input a command for controlling the robot. In this case, the command input by the user may be transmitted to the information processing system 120 through the user terminal 110.

The user terminal 110 may transmit a command to execute a task using a specific intelligence to a specific robot. Specifically, the command input from the user may be transmitted to the information processing system 120 through the user terminal 110, and the command transmitted to the information processing system 120 may be transmitted back to the robot 130. In this example, the command for controlling the robot may include a command for executing a specific intelligence on a robot, a command for stopping a specific intelligence running on a robot, a command for stopping all intelligences running on a robot, a command for outputting the status of a software platform of a robot, and the like, although embodiments are not limited thereto.

Meanwhile, the command transmitted to the information processing system 120 by the user terminal 110 may be stored or recorded in a database (not illustrated) capable of communicating with the robot 130. The database capable of communicating with the robot 130 may include a storage space and the like that can be continuously sensed from the robot 130 having read permission. That is, when a specific command is stored or recorded in the database by the user, the robot 130 may sense the command stored in the database.

The robot 130 may execute a task based on the command input from the user terminal 110. For example, the robot 130 may execute a task of identifying an obstacle on a path or a task of determining a color of an object on a path. As the task is executed, data collected by the robot 130 (e.g., data on obstacle on the path, data on color of an object on the path, and the like) may be transmitted to the information processing system 120. In other words, the information processing system 120 may receive data generated or acquired as the robot 130 executes a task.

According to an embodiment, the information processing system 120 may transmit the data received from the robot 130 to an intelligence augmentation system (not illustrated). The intelligence augmentation system may refer to an external device capable of generating augmented intelligence based on the data collected from the robot 130. For example, the intelligence augmentation system may include one or more artificial neural network models trained to generate augmented intelligence based on the collected data.

Then, the information processing system 120 may receive the intelligence augmented based on the data collected by the robot 130 from the intelligence augmentation system. The augmented intelligence may be registered in the registry. In this example, the augmented intelligence may refer to robot intelligence with improved or advanced performance, and for example, an intelligence generated using data collected by an obstacle identification intelligence and data collected from a color determination intelligence may be an intelligence that is augmented to determine an obstacle and a color of the obstacle on the path.

According to an embodiment, the robot 130 may include a control unit capable of communicating with the information processing system 120 and a software platform capable of using a container-based intelligence. In this example, the container may refer to a technology for packaging and isolating elements (executable files, application engines, and the like) necessary for the intelligence to operate in the robot 130, and the software platform may refer to a program for distributing and executing the container-based intelligence.

The control unit included in the robot 130 may communicate with the information processing system 120, receive a command for the robot, and control a motion of the robot 130. Specifically, the control unit may search a database capable of communicating with the information processing system 120 to determine whether or not a command associated with controlling of the robot 130 is included. When a command associated with controlling of the robot 130 is included, the control unit may receive a container-based intelligence corresponding to the command from the information processing system 120. Then, the control unit may control the robot 130 to execute a task using the received container-based intelligence.

Meanwhile, one robot can communicate and exchange data with another robot. Specifically, a robot with limited computing resources, memory, and the like may transmit the collected data to other systems (e.g., another robot, center cloud, edge cloud, and the like) having sufficient computing resources, memory, and the like to process complex tasks. Then, the robot may receive the task results generated by analyzing the data collected from the other systems. For example, in order to communicate with the other systems, a communication method such as socket communication, Robot Operating System (ROS)-based communication, REpresentational State Transfer (REST), and the like may be used.

With this configuration, user can efficiently process a task using the robot by utilizing the continuously-augmented intelligence, and by use of the software platform, the robot may utilize the augmented intelligence regardless of factors (e.g., system environment, computing resources, and the like) required to operate the intelligence.

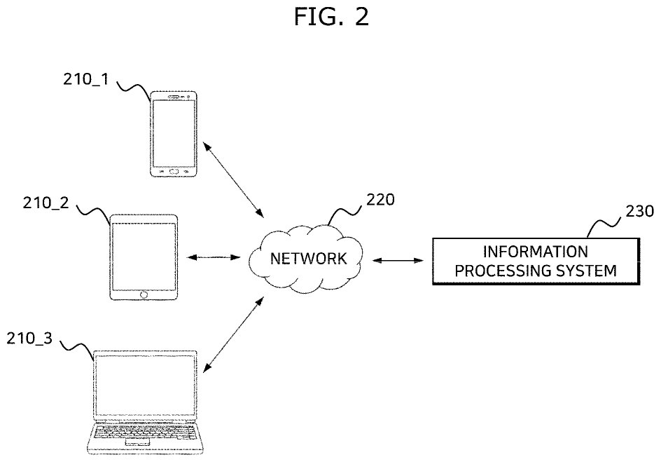

FIG. 2 is a schematic diagram illustrating a configuration in which an information processing system 230 is communicatively connected to a plurality of user terminals 210_1, 210_2, and 210_3 to control a robot and share augmented intelligence according to an embodiment. The plurality of user terminals 210_1, 210_2, and 210_3 may be the terminals of a developer that include a Command-Line Interface (CLI) and the like, or the terminals of a user that include a dashboard and the like for controlling the robot. The information processing system 230 may include a system for controlling a robot or sharing an augmented intelligence via a network 220. According to an embodiment, the information processing system 230 may include one or more server devices and/or databases, or one or more distributed computing devices and/or distributed databases based on cloud computing services that can store, provide and execute computer-executable programs (e.g., downloadable applications) and data related to controlling of a robot and sharing of augmented intelligence.

The controlling of a robot and sharing of augmented intelligence provided by the information processing system 230 may be provided to the user through an application associated with the controlling of a robot installed in each of the plurality of user terminals 210_1, 210_2, and 210_3. For example, the user may be provided with a user interface including information on one or more robots, information on intelligence registered in registry and the like, through an application associated with the controlling of a robot. In this case, the user can control the robot or share intelligence by using the information included in the user interface and available API.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device, RS-serial communication, and the like, a wireless network such as a mobile communication network, a wireless LAN (WLAN), Wi-Fi, Bluetooth, ZigBee, and the like, or a combination thereof, depending on the installation environment. The method of communication may include a communication method using a communication network (e.g., mobile communication network, wired Internet, wireless Internet, broadcasting network, satellite network, and the like) that may be included in the network 220 as well as short-range wireless communication between user terminals 210_1, 210_2, and 210_3, but embodiments are not limited thereto.

In FIG. 2, a mobile phone terminal 210_1, a tablet terminal 210_2, and a PC terminal 210_3 are illustrated as the examples of the user terminals, but embodiments are not limited thereto, and the user terminals 210_1, 210_2, and 210_3 may be any computing device that is capable of wired and/or wireless communication and that can be provided with a user interface such as a CLI or a dashboard. For example, the user terminal may include a smart phone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and the like. In addition, FIG. 2 illustrates that three user terminals 210_1, 210_2, and 210_3 are in communication with the information processing system 230 through the network 220, but embodiments are not limited thereto, and a different number of user terminals may be configured to be in communication with the information processing system 230 through the network 220.

According to an embodiment, the information processing system 230 may transmit at least one of information on one or more robots or information on intelligence registered in the registry to the user terminals 210_1, 210_2, and 210_3. Then, a user interface including the information transmitted to the user terminals 210_1, 210_2, and 210_3, an API list, and the like may be displayed on the displays of the user terminals 210_1, 210_2, and 210_3. In this example, the information on one or more robots may include at least one of a list of robots including one or more robots that are capable of communication, types of intelligences running on the one or more robots, or number of intelligences running on the one or more robots.

Then, the information processing system 230 may receive a command for controlling one or more robots based on the intelligence registered in the registry from the user terminals 210_1, 210_2, and 210_3. For example, for a command for controlling one or more robots, when the user selects a user interface through a touch input or the like, the selected information may be received by the user terminals 210_1, 210_2, and 210_3. Then, the information received by the user terminals 210_1, 210_2, and 210_3 may be transmitted to the information processing system 230. In this example, the command for controlling one or more robots may include at least one of a command for executing a specific intelligence on one or more robots, a command for stopping a specific intelligence running on one or more robots, a command for stopping all intelligences running on one or more robots, or a command for outputting the status of a container platform for one or more robots.

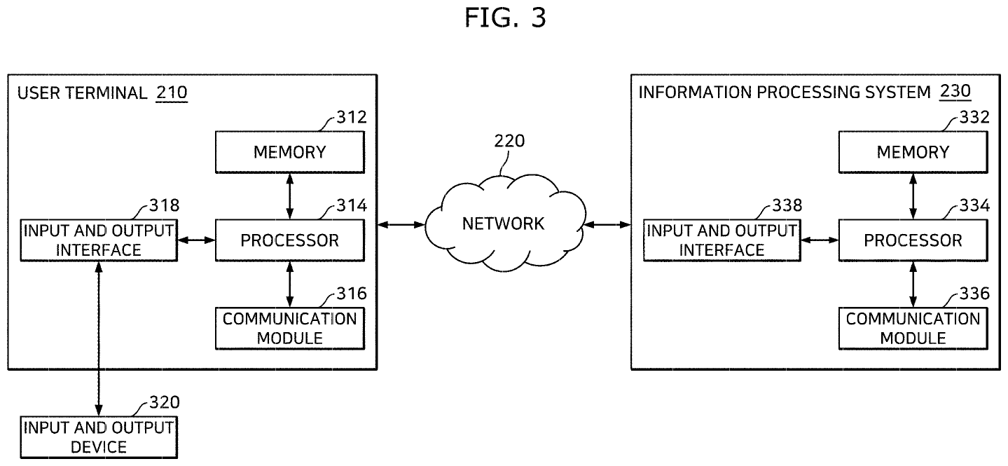

FIG. 3 is a block diagram illustrating an internal configuration of the user terminal 210 and the information processing system 230 according to an embodiment. The user terminal 210 may refer to any computing device that is capable of executing an application associated with controlling of a robot and sharing of robot intelligence and also capable of wired/wireless communication, and may include the mobile phone terminal 210_1, the tablet terminal 210_2, and the PC terminal 210_3 of FIG. 2, for example. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using the respective communication modules 316 and 336. In addition, an input and output device 320 may be configured to input information and/or data to the user terminal 210 or to output information and/or data generated from the user terminal 210 through the input and output interface 318.

The memories 312 and 332 may include any non-transitory computer-readable recording medium. According to an embodiment, the memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. In addition, an operating system and at least one program code (e.g., a code for an application, and the like installed and driven in the user terminal 210) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and so on, for example. As another example, the software components may be loaded into the memories 312 and 332 through the communication modules rather than the computer-readable recording medium. For example, at least one program may be loaded into the memories 312 and 332 based on a computer program (e.g., an application associated with controlling of a robot and sharing of robot intelligence) installed by the files provided by the developers or a file distribution system for distributing an installation file of the application through the network 220.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system or the like). For example, a request or data (e.g., for executing a specific intelligence on the robot, for stopping a specific running intelligence, for stopping all running intelligences, for outputting the status of a software platform, and the like) generated by the processor 314 of the user terminal 210 according to the program code stored in a recording device such as the memory 312 or the like may be transmitted to the information processing system 230 through the network 220 under the control of the communication module 316. Conversely, a control signal or a command provided under the control of the processor 334 of the information processing system 230 may be received by the user terminal 210 through the communication module 316 of the user terminal 210 via the communication module 336 and the network 220. For example, the user terminal 210 may receive from the information processing system 230 and through the communication module 316, a list of robots including one or more robots capable of communication, types of intelligences running on one or more robots, number of intelligences running on one or more robots, and the like.

The input and output interface 318 may be a means for interfacing with the input and output device 320. As an example, the input device may include a device such as a camera, a keyboard, a microphone, a mouse, and so on, which includes an audio sensor and/or an image sensor, and the output device may include a device such as a display, a speaker, a haptic feedback device, and so on. As another example, the input and output interface 318 may be a means for interfacing with a device, such as, for example, a touch screen or the like that integrates a configuration or function for performing inputting and outputting. For example, when the processor 314 of the user terminal 210 processes the command of the computer program loaded in the memory 312, a service screen, information on a robot, information on intelligence registered in the registry, and the like, which is configured with the information and/or data provided by the information processing system 230 or other user terminals, may be displayed on the display through the input and output interface 318. While FIG. 3 illustrates that the input and output device 320 is not included in the user terminal 210, embodiments are not limited thereto, and the input and output device 320 may be configured as one device with the user terminal 210. In addition, the input and output interface 338 of the information processing system 230 may be a means for interfacing with a device (not illustrated) for inputting or outputting, which may be connected to the information processing system 230 or included in the information processing system 230. In FIG. 3, while the input and output interfaces 318 and 338 are illustrated as the components configured separately from the processors 314 and 334, embodiments are not limited thereto, and the input and output interfaces 318 and 338 may be configured to be included in the processors 314 and 334.

The user terminal 210 and the information processing system 230 may include more components than the components illustrated in FIG. 3. Meanwhile, most of the related components may not necessarily require exact illustration. According to an embodiment, the user terminal 210 may be implemented to include at least a part of the input and output device 320 described above. In addition, the user terminal 210 may further include other components such as a transceiver, a Global Positioning System (GPS) module, a camera, various sensors, a database, and the like. For example, when the user terminal 210 is a smartphone, it may generally include components included in the smartphone, and for example, it may be implemented such that various components such as an acceleration sensor, a gyro sensor, a camera module, various physical buttons, buttons using a touch panel, input and output ports, a vibrator for vibration, and so on are further included in the user terminal 210.

According to an embodiment, the processor 314 of the user terminal 210 may be configured to operate an application for controlling a robot or sharing intelligence. In this case, the program code associated with the corresponding application may be loaded into the memory 312 of the user terminal 210. While the application is running, the processor 314 of the user terminal 210 may receive information and/or data provided from the input and output device 320 through the input and output interface 318 or receive information and/or data from the information processing system 230 through the communication module 316, and process the received information and/or data and store it in the memory 312. In addition, such information and/or data may be provided to the information processing system 230 through the communication module 316.

While the application for controlling a robot or sharing intelligence is running, the processor 314 may receive text, image, video, and the like input or selected through the input device such as a camera, a microphone, and the like that includes a touch screen, a keyboard, an audio sensor and/or an image sensor connected to the input and output interface 318, and store the received text, image, and/or video or the like in the memory 312, or provide it to the information processing system 230 through the communication module 316 and the network 220.

According to an embodiment, the processor 314 may provide the information input by the user through the input device to the information processing system 230 through the network 220 and the communication module 316. For example, a command for controlling a robot received by a user's action (e.g., touch input, scroll input, and the like) may be provided to the information processing system 230 through the network 220 and the communication module 316.

The processor 334 of the information processing system 230 may be configured to manage, process, and/or store the information and/or data received from a plurality of user terminals and/or a plurality of external systems. In an embodiment, the processor 334 may receive a command for controlling one or more robots from the user terminal 210. Then, the information processing system 230 may store information associated with the received input in a database capable of communicating with one or more robots.

According to an embodiment, the information processing system 230 may receive data collected from the execution of tasks by one or more robots that execute the tasks based on information stored in the database. The collected data as described above may be transmitted to the intelligence augmentation system. Then, the information processing system 230 may receive an augmented intelligence that is augmented based on the collected data from the intelligence augmentation system, and register the received augmented intelligence in the registry.

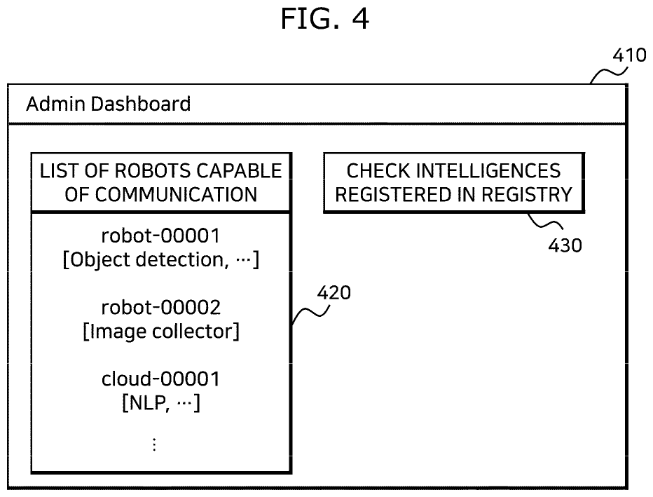

FIG. 4 is a diagram illustrating an example of an initial user interface 410 including information on robot, information on intelligence registered in the registry, and the like according to an embodiment. According to an embodiment, the user interface 410 may be a screen provided to the user through the user terminal to control the robot or share the robot intelligence, and may include a dashboard, CLI, and the like. That is, when a specific area on the user interface 410 is selected by the user, a command or the like associated with the selected specific area may be transmitted to the information processing system. The user interface 410 may be provided through an application installed in the user terminal, or may be provided through a web page associated with controlling of a robot.

As illustrated, the user interface 410 may include a list of robots 420 capable of communication, and information on intelligence 430 registered in the registry. For example, the list of robots 420 capable of communication includes a name of a robot (“robot-00001”, “robot-00002”, “cloud-00001”, and the like) and intelligence (object detection, image collector, natural language processing (NLP), and the like), and the like running on each robot. One or more intelligences may be executed in one robot, and each robot may include different computing resources. In the illustrated example, “robot-00001” may be a system in which intelligence including object detection is being executed, and “cloud-00001” may be a system that includes more computing resources than “robot-00001”.

In FIG. 4, the user interface 410 is illustrated as including the list of robots 420 capable of communication, and the information on the intelligence 430 registered in the registry, but embodiments are not limited thereto. According to an embodiment, the user interface 410 may further include information on area for distributing the intelligence augmented by the intelligence augmentation system in the registry, types of intelligences running on the robot, number of intelligences running on the robot, current location of robot, ratio of computing resources being used by robot, and the like. With this configuration, the user can easily check the information on the currently available robots, and control various tasks of the robot through a simple touch input or the like through the user interface 410.

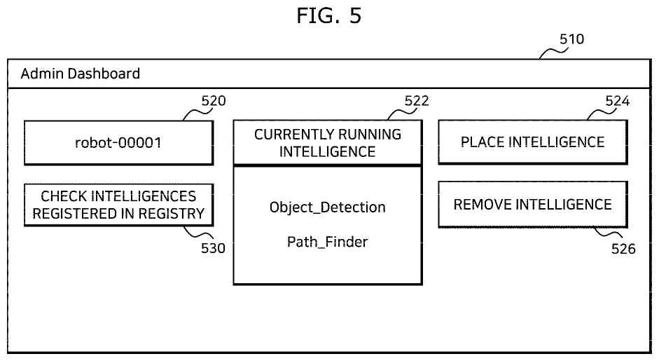

FIG. 5 is a diagram illustrating an example of a user interface 510 that includes detailed information on one robot according to an embodiment. According to an embodiment, when one of the robots capable of communication is selected by the user, the user interface 510 including detailed information on the selected robot may be displayed on the display. For example, when the user selects “robot-00001” from the list of robots 420 capable of communication displayed on the initial user interface 410 of FIG. 4, the user interface 510 including detailed information on the selected “robot-00001” may be displayed.

As illustrated, the user interface 510 may include a name 520 of the selected robot, information 530 on intelligence registered in the registry, intelligence 522 currently running on the selected robot, and an area 524 for placing a new intelligence in the selected robot, an area 526 for removing the intelligence placed in the selected robot, and the like. For example, the intelligence currently running on “robot-00001” may correspond to object detection and path finder, and when the user selects one intelligence between the object detection and the path finder and selects the area 526 for removing intelligence, the corresponding intelligence may be removed from “robot-00001”. In another example, when the user selects some of the intelligences registered in the registry and selects the area 524 for placing the intelligences, the corresponding intelligences may be placed in “robot-00001”.

FIG. 5 illustrates that the user interface 510 includes the name 520 of the selected robot, the information 530 on the intelligence registered in the registry, the intelligence 522 currently running on the selected robot, and the area 524 for placing a new intelligence in the selected robot, the area 526 for removing the intelligence placed in the selected robot, and the like, but embodiments are not limited thereto. For example, the user interface 510 may further include information on a current location of the selected robot, a ratio of computing resources being used by the selected robot, and the like. With this configuration, the user can easily check the information on the selected robot and simply control the selected robot through the user interface 510.

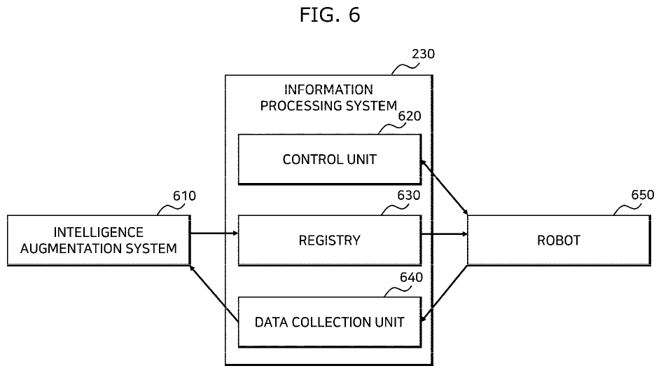

FIG. 6 is a functional block diagram illustrating an internal configuration of the information processing system 230 according to an embodiment. As illustrated, the information processing system 230 may include a control unit 620, a registry 630, a data collection unit 640, and the like. In addition, the information processing system 230 may communicate and exchange data, information, and the like with an intelligence augmentation system 610 and a robot 650.

According to an embodiment, the control unit 620 may refer to a module configured to integrate and manage robots, and may be configured to provide an environment in which the user terminal and the robots can communicate with each other. For example, when the user transmits a specific command through the user interface displayed on the user terminal, the control unit 620 may transmit the received specific command to the robot 650 through the API. Specifically, when receiving a specific command from the user, the control unit 620 may record or store information associated with the command in a database.

By the registry 630, it may refer to a storage space that stores existing intelligence that can be executed in the robot 650, augmented intelligence received from the intelligence augmentation system, and the like. According to an embodiment, the registry 630 may include information necessary to execute the intelligence (e.g., source code, libraries, dependency tools, other files, and the like). Additionally or alternatively, the registry 630 may include a container that can be generated using the information necessary to execute intelligence so as to be executed in various system environments of a robot.

According to an embodiment, by the data collection unit 640, it may refer to a storage space capable of receiving and storing data, task results, and the like collected as the robot 650 executes the task. That is, the data collection unit 640 may correspond to a storage space for collecting data for augmenting intelligence. For example, when a task is executed by the robot 650, the data collection unit 640 may directly communicate with an application associated with the task, to receive data, task results, and the like generated as the task is executed. Then, the data collection unit 640 may transmit the collected data to the intelligence augmentation system 610 to augment the intelligence. According to an embodiment, the intelligence augmentation system 610 may use the data collected from the data collection unit 640 to augment the intelligence and transmit the augmented intelligence to the registry 630. Accordingly, the augmented intelligence may be registered in the registry 630. For example, the intelligence augmentation system 610 may be configured to use the data stored in the data collection unit 640 to update an existing artificial neural network model, thereby improving the performance of the corresponding artificial neural network model. In this case, the registry 630 may receive the updated artificial neural network model from the intelligence augmentation system 610 and register the same.

FIG. 6 illustrates that the intelligence augmentation system 610 is not included in the information processing system 230, but embodiments are not limited thereto. According to an embodiment, the information processing system 230 may include an intelligence augmentation system 610 for augmenting an intelligence. In addition, although the components of the information processing system 230 have been described separately for each function in FIG. 6, it does not necessarily mean that they are physically separated. For example, the registry 630 and the data collection unit 640 have been separately described above, but this is only to help the understanding of the disclosure, and one storage space installed in the information processing system 230 may perform two or more functions or, one computing device may perform two or more functions.

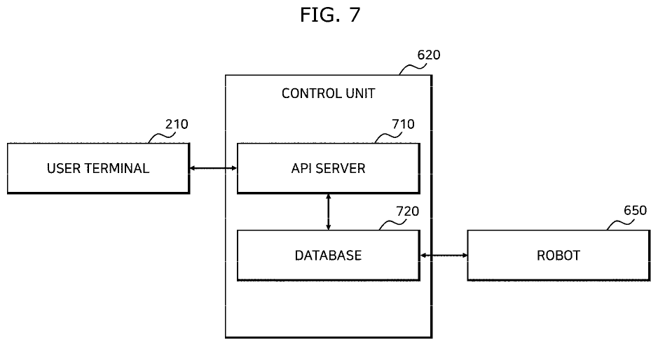

FIG. 7 is a functional block diagram illustrating an internal configuration of the control unit 620 according to an embodiment. As illustrated, the control unit 620 may include an API server 710 and a database 720, although embodiments are not limited thereto. The control unit 620 may communicate and exchange data, information, and the like with the user terminal 210, the robot 650, and the like.

According to an embodiment, the API server 710 may communicate with the user terminal 210 and receive a command for controlling the robot 650. For example, the user terminal 210 may be a terminal of a user or a developer for controlling the robot 650, and may include a terminal of a user on which a user interface (e.g., a dashboard, CLI, and the like) including information on robot, information on intelligence registered in the registry, and the like is displayed. In this example, the user interface may include information associated with an API list that can be processed by the API server 710. For example, the API list may include an API for checking the currently connected robot, an API for checking the status of software platform of a specific robot, an API for executing an intelligence on a specific robot, an API for stopping an intelligence running on a specific robot, an API for stopping all intelligence running on a specific robot, and an API for distributing an augmented intelligence in the registry, and the like. That is, the user may select information associated with the API list displayed on the user interface, and transmit, to the API server 710, at least one of a command for executing a specific intelligence on one or more robots, a command for stopping a specific intelligence running on one or more robots, a command for stopping all intelligences running on one or more robots, or a command for outputting the status of a software platform for one or more robots.

Then, the API server 710 may record or store the information received from the user terminal 210 in the database 720. The database 720 may be a storage space capable of communicating with the robot 650, and may refer to any space that can be periodically sensed by the robot 650. For example, the robot 650 may read or sense the information on the database 720 at 10-second intervals. In this case, communication between the user terminal 210 and the robot 650 may be performed via the database 720.

FIG. 7 illustrates that one the robot 650 communicates with the information processing system 230, but embodiments are not limited thereto, and a plurality of robots may communicate and exchange data, information, and the like with the information processing system 230. In addition, although it has been described above in FIG. 7 that all commands for a plurality of robots are recorded or stored in one database, embodiments are not limited thereto. For example, a separate database may be provided for each robot, and an area on one database may be divided and provided for each robot.

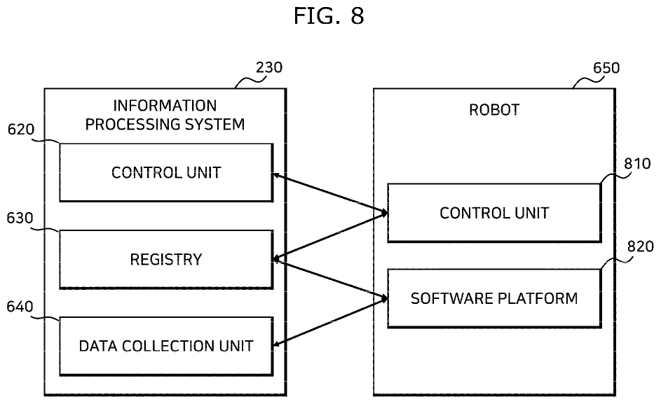

FIG. 8 is a functional block diagram illustrating an internal configuration of the robot 650 capable of communicating with the information processing system 230 according to an embodiment. As illustrated, the robot 650 may include a control unit 810 capable of communicating with the information processing system 230 and a software platform 820 capable of using intelligence, but embodiments are not limited thereto. As described above, the robot 650 may execute or process a task, while communicating with each module included in the information processing system 230.

According to an embodiment, the control unit 810 may refer to a module provided in the robot 650 to control the operation of the robot 650. The control unit 810 may continuously communicate with the control unit 620, and may sense a database included in the control unit 620 and thus receive a command. In addition, the control unit 810 may transmit to the control unit 620 the information on the robot 650, including whether or not it is currently available, its current state, type of intelligence currently being executed, a ratio of remaining computing resources, and the like.

The software platform 820 may refer to open source software capable of executing the container-based intelligence, and may include Docker, Kubernetes, and the like, for example, but embodiments are not limited thereto. For example, it may further include separate software capable of executing the container-based intelligence.

According to an embodiment, the control unit 810 may search a database capable of communicating with the control unit 620 to determine whether or not a command associated with controlling of a robot is included. In this example, the control unit 810 may sense the database at a specific time interval (e.g., 1 second, 5 seconds, 10 seconds, and the like) to determine whether or not a command associated with controlling of a robot is included. For example, when a command for the robot 650 is included in the database included in the control unit 620, the control unit 810 may stop the intelligence currently executed in the robot 650 according to the command, or may receive a new intelligence and distribute it to the robot 650.

When the command associated with controlling of a robot is included, the control unit 810 may receive a container-based intelligence corresponding to the command from the registry 630. The container-based intelligence received from registry 630 may be stored on the software platform 820. Then, the control unit 810 may execute a task by executing the intelligence stored in the software platform 820.

Additionally or alternatively, when the command associated with controlling of a robot is a command for executing an intelligence already present in the robot 650 or a command for stopping the intelligence present in the robot 650, the control unit 810 may execute the task by directly using a pre-stored intelligence in the software platform 820 without receiving the container-based intelligence from the registry 630.

Meanwhile, when the task is executed by the robot 650, the data, the task result, and the like collected along the execution of the task may be transmitted to the data collection unit 640. In other words, each intelligence included in the software platform 820 may directly communicate with the data collection unit 640 and transmit the data associated with the task.

FIG. 8 illustrates that one robot 650 communicates with each module included in the information processing system 230, but embodiments are not limited thereto, and a plurality of robots may communicate and exchange data, information, and the like with the information processing system 230. With this configuration, the user can efficiently execute the tasks using various robots without considering the system environment and the like of the robot by utilizing container-based intelligence.

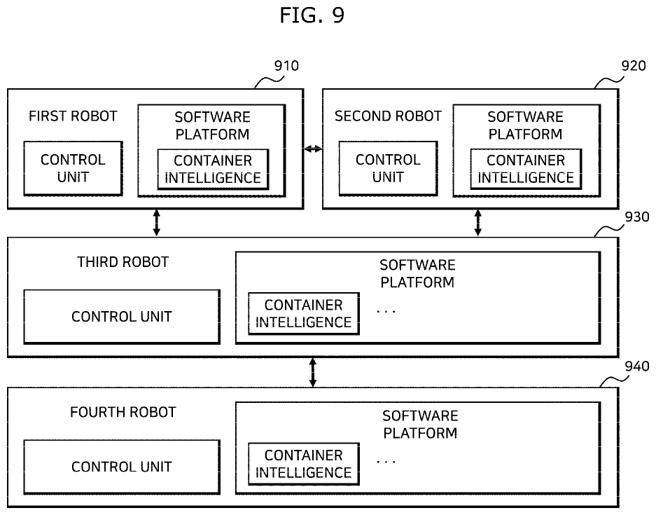

FIG. 9 is a diagram illustrating an example in which communication is performed between a plurality of robots 910, 920, 930, and 940 according to an embodiment. As illustrated, a first robot 910, a second robot 920, a third robot 930, and a fourth robot 940 communicate with each other and may exchange data/information, and the like. For example, the first robot 910 and the second robot 920 may each correspond to a robot system including a small computing resource, and the third robot 930 may include a robot system such as an edge cloud system, for example, which includes more computing resources than those of the first robot 910 and the second robot 920. In addition, the fourth robot 940 may be a robot system such as a center cloud system, for example, which includes more abundant computing resources than those of the first robot 910, the second robot 920 and the third robot 930.

According to an embodiment, the first robot 910 may execute a task by executing a specific intelligence. In this case, the first robot 910 may collect the data generated according to execution of the task and directly process the collected data to generate a task result. According to another embodiment, the first robot 910 may collect the data generated according to execution of the task, and transmit the collected data to the second robot 920, the third robot 930, the fourth robot 940, and the like, and then receive the task results from the second robot 920, the third robot 930, the fourth robot 940, and the like. According to another embodiment, the first robot 910 may transmit some of the collected data to at least one of the second robot 920, the third robot 930, and the fourth robot 940, and then generate a task result in conjunction with at least one of the robots 920, 930, and 940.

According to an embodiment, the plurality of robots 910, 920, 930, and 940 may communicate using the socket communication, the ROS-based communication, the REST, and the like. In other words, the first robot 910 may transmit the collected data to one or more of the other robots that are capable of communication using the socket communication, the ROS-based communication, the REST, and the like. For example, an application running on the first robot 910 may directly communicate with an application of another robot to exchange data, information, and the like.

According to an embodiment, when the first robot 910 has insufficient computing resources for processing the collected data, it may receive the task result from the other robots 920, 930, and 940. Specifically, the first robot 910 may determine whether or not it includes computing resource to process the collected data, and in response to determining that the first robot 910 does not have sufficient computing resources to process the collected data, transmit the collected data to one or more of the other robots. In this example, the one or more of the other robots may correspond to at least one of the second robot 920, the third robot 930, and the fourth robot 940, which may have available computing resources left or have abundant computing resources. With this configuration, even when the computing resource of a specific robot is insufficient, the user can process the collected data using another robot and the like, so that the user can command to execute tasks efficiently regardless of the computing resources of the specific robot.

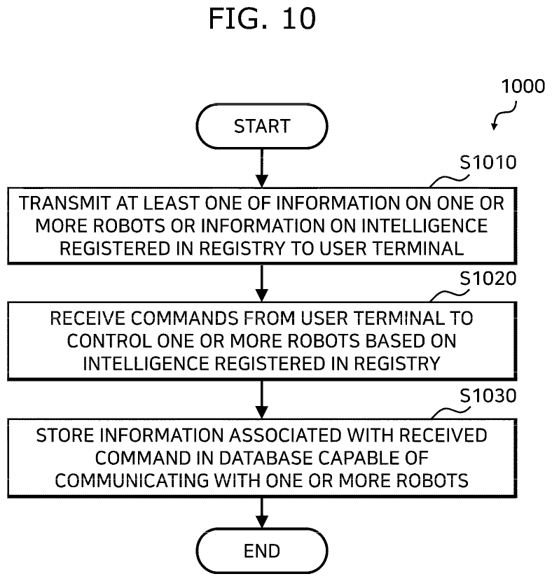

FIG. 10 is a diagram illustrating an example of a method 1000 for augmenting and sharing a robot intelligence based on a container according to an embodiment. According to an embodiment, the method 1000 for augmenting and sharing a robot intelligence based on a container may be performed by the information processing system (e.g., at least one processor of the information processing system). The method 1000 for augmenting and sharing a robot intelligence based on a container may be initiated by the processor transmitting at least one of information on one or more robots or information on intelligence registered in the registry to the user terminal (S1010). In this example, the information on one or more robots may include at least one of a list of robots including one or more robots capable of communication, types of intelligences running on the one or more robots, or number of intelligences running on the one or more robots.

The processor may receive a command for controlling the one or more robots based on the intelligence registered in the registry from the user terminal (S1020). In addition, the processor may store information associated with the received input in a database capable of communicating with one or more robots (S1030). In this example, the command for controlling one or more robots may include at least one of a command for executing a specific intelligence on one or more robots, a command for stopping a specific intelligence running on one or more robots, a command for stopping all intelligences running on one or more robots, or a command for outputting the status of a software platform for one or more robots.

Meanwhile, the processor may receive the data collected from the execution of a task from one or more robots that execute the tasks based on the information stored in the database, and then transmit the collected data to the intelligence augmentation system. Then, the processor may receive an augmented intelligence that is augmented based on the data collected from the intelligence augmentation system, and register the received augmented intelligence in the registry.

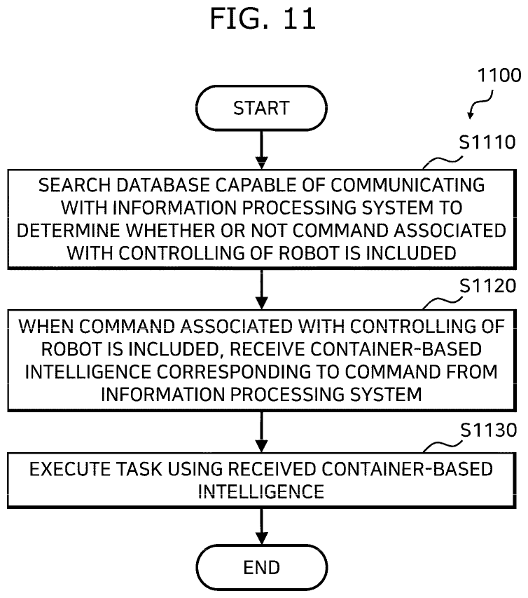

FIG. 11 is a diagram illustrating an example of a method 1100 for operating a robot based on a container according to an embodiment. According to an embodiment, the method 1100 for operating a robot based on a container may be performed by the information processing system (e.g., at least one processor of the information processing system). The method 1100 for operating a robot based on a container may be initiated by the processor searching a database capable of communicating with the information processing system, and determining whether or not a command associated with controlling of a robot is included (S1110). In this example, the robot may include a control unit capable of communicating with the information processing system and a software platform capable of using intelligence.

When a command associated with controlling of a robot is included, the processor may receive a container-based intelligence corresponding to the command from the information processing system (S1120). That is, the processor may receive the container-based intelligence from the registry included in the information processing system. That is, the registry may include the augmented intelligence received from the existing intelligence and the intelligence augmentation system.

Then, the processor may execute a task using the received container-based intelligence (S1130). According to an embodiment, while communicating with one or more of the other robots, the processor may process the data generated according to the execution of tasks. Specifically, the processor may collect the data generated according to the execution of tasks, transmit the collected data to one or more of the other robots, and then receive task results generated based on the data from the one or more of the other robots. In this case, the processor may transmit the collected data to one or more of the other robots that are capable of communication using at least one of Socket communication, ROS, or REST. Additionally or alternatively, the processor may determine whether or not the robot includes the computing resources to process the collected data, and in response to determining that the robot does not have sufficient computing resources to process the collected data, transmit the collected data to one or more of the other robots.

The method for augmenting and sharing a robot intelligence based on a container and the method for operating a robot based on a container described above may be provided as a non-transitory computer-readable recording medium storing instructions for execution in a computer. The medium may continuously store a program executable by a computer or temporarily store a program for execution or download. In addition, the medium may be a variety of recording means or storage means in a form in which a single piece of hardware or several pieces of hardware are combined, but is not limited to a medium directly connected to any computer system, and may be present on a network in a distributed manner. An example of the medium includes a medium that is configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the embodiments described above have been described as utilizing aspects of the currently disclosed subject matter in one or more standalone computer systems, embodiments are not limited thereto, and may be implemented in conjunction with any computing environment, such as a network or distributed computing environment. Furthermore, aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. Further, such modifications and changes are intended to fall within the scope of the claims appended herein.

What is claimed is:

1. A method for augmenting and sharing a robot intelligence based on a container, the method performed by at least one processor of an information processing system and comprising:
transmitting at least one of information on one or more robots or information on intelligence registered in a registry to a user terminal;
receiving a command for controlling the one or more robots based on the intelligence registered in the registry from the user terminal; and
storing information associated with the received command in a database capable of communicating with the one or more robots.

2. The method according to claim 1, wherein the information on the one or more robots includes at least one of a list of robots including the one or more robots, types of intelligences running on the one or more robots, or a number of intelligences running on the one or more robots.

3. The method according to claim 1, wherein the command for controlling the one or more robots includes at least one of a command for executing a specific intelligence on the one or more robots, a command for stopping a specific intelligence running on the one or more robots, a command for stopping all intelligences running on the one or more robots, or a command for outputting a status of a software platform for the one or more robots.

4. The method according to claim 1, comprising:
receiving data generated by executing a task from the one or more robots that execute the task based on the information stored in the database;
transmitting the received data to an intelligence augmentation system;
receiving an intelligence augmented based on the received data from the intelligence augmentation system; and
registering the intelligence received from the intelligence augmentation system in the registry.

5. An information processing system comprising:
a communication module;
a memory; and
at least one processor connected to the memory and configured to execute one or more computer-readable programs included in the memory,
wherein the at least one program includes instructions for:
transmitting at least one of information on one or more robots or information on intelligence registered in a registry to a user terminal;
receiving a command for controlling the one or more robots based on the intelligence registered in the registry from the user terminal that received the information; and
storing information associated with the received command in a database capable of communicating with the one or more robots.

6. A method for operating a robot based on a container, the method performed by at least one processor of a robot and comprising:
searching a database capable of communicating with an information processing system to determine whether or not a command associated with controlling of the robot is included;
when the command associated with controlling of the robot is included, receiving a container-based intelligence corresponding to the command from the information processing system; and
executing a task using the received container-based intelligence.

7. The method according to claim 6, wherein the robot includes a control unit capable of communicating with the information processing system, and a software platform capable of using the intelligence.

8. The method according to claim 6, further comprising:
collecting data according to the executing of the task;
transmitting the collected data to one or more other robots; and
receiving task results generated based on the data from the one or more other robots.

9. The method according to claim 8, wherein the transmitting the collected data to one or more other robots includes:
transmitting the collected data to the one or more other robots that are capable of communication using at least one of socket communication, Robot Operating System (ROS)-based communication, or REpresentational State Transfer (REST).

10. The method according to claim 8, further comprising:
determining whether or not the robot includes a computing resource to process the collected data,
wherein the transmitting the collected data to one or more other robots includes, in response to determining that the robot does not have sufficient computing resource to process the collected data, transmitting the collected data to the one or more other robots.
